(19) United States
(12) Patent Application Publication
(10) Pub. No.: US 2010/0260070 A1
(43) Pub. Date: Oct. 14, 2010

(54) Localized construction of fault resilient high capacitywireless networks with bounded node degree

(76) Inventors: Yigal Bejerano, Springfield, NJ (US); Qunfeng Dong, Suzhou Jiangsu (CN)

Correspondence Address: HARNESS, DICKEY & PIERCE, P.L.C., P.O. BOX 8910, RESTON, VA, 20195, US

(21) Appl. No.: 12/385,484

(22) Filed: Apr. 9, 2009

(51) Int. Cl. H04L 12/28

(52) U.S. Cl. 370/255

(57) ABSTRACT

Embodiments described include methods of determining neighboring nodes with which to link a subject node in a wireless communication network. Depending on the network preferences, the links between neighbor nodes and the subject node may include high capacity links or fault resilient high capacity links. The number of neighboring nodes may be as high as ten in a fault resilient high capacity network and five or less for a high capacity network.

### BACKGROUND OF THE INVENTION

This section introduces aspects that may be helpful in facilitating a better understanding of the invention. Accordingly, the statements of this section are to be read in this light and are not to be understood as admissions about what is in the prior art or what is not in the prior art.

Multi-hop wireless networks have been widely recognized as a low cost fast deployed technology for various applications such as disaster recovery networks, wireless backhaul, public Internet access, etc. In such systems, a collection of wireless communication devices, referred to as nodes, self-organize into a multi-hop wireless network. Each node communicates with other nodes in its vicinity and together they operate as relays for forwarding packets between source-destination pairs that may be several hops away. However, due to the dynamic ad hoc nature of such systems, they may be plagued by unpredictable interference, noise, node and/or link failure, and limited energy supply, each of which can significantly hinder performance.

In such systems, each node is equipped with a few directional antennas, e.g., three to twenty. Although, typically the number of directional antennas is about 3 to 6, for example, if a node has 3 directional antennas, two routers may be connected back-to-back to obtain a single router with 6 directional antennas. Each antenna is used for establishing a point-to-point link with another antenna on a neighboring node. Thus in such a constructed network, each node cannot have more links than its number of installed antennas, which in turn defines a degree bound on all nodes.

### SUMMARY OF THE INVENTION

Embodiments of the present invention are directed to localized methods for building fault resilient wireless networks that contain paths with the highest possible capacity for every pair of nodes, under standard conditions and in the presence of node and/or link failures. Embodiments also include methods for building fault resilient wireless networks with the lowest possible degree bound. Other embodiments include constructing fault resilient and high capacity networks with bounded node degree. To form these networks, embodiments of the present invention include methods of determining neighbor nodes with which to link in a wireless communication network.

An embodiment of the present invention includes a method of determining neighboring nodes with which to link in a wireless communication network. The method includes, determining, at a subject node, a set of five or less neighbor nodes from a plurality of neighbor nodes neighboring the subject node. The method also includes communicating, from the subject node, over at least one link to at least one of the determined set of neighbor nodes. The links over which the subject node communicates are high capacity links.

Another embodiment further includes determining a preferred set of neighbor nodes from the plurality of neighbor nodes, excluding the determined set of five or less neighbor nodes. The subject node may then communicate over at least one link to at least one of the determined set of neighbor nodes and over the at least one link to at least one of the determined preferred set of neighbor nodes. The links over which the subject node communicates are fault resilient high capacity links.

In another embodiment, the method further includes determining at least two paths including one or more links, between the subject node and at least one neighbor node from the set of neighbor nodes and the preferred set of neighbor nodes. The method also includes, removing links corresponding to a third path between the subject node and the at least one neighbor node from the links over which the subject node communicates. The links over which the subject node communicates are fault resilient links.

Other embodiments include computer readable mediums encoded with methods of determining neighboring nodes with which to link a subject node in a wireless communication network, where the method includes the steps described above.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 shows a network subgraph of node u with a maximum of five or less neighbor nodes 1 to 5 and a neighbor node v a distance d+ε from node u, according to an embodiment of the present invention;

FIG. 2 shows the lune of the links between nodes u and v, when nodes u and v are relative neighbor nodes, according to an embodiment of the present invention;

FIG. 3 shows a network subgraph of a node u with an unbounded degree of neighbors, according to an embodiment of the present invention;

FIG. 4 shows a network subgraph of node u, where the value near each link denotes the distance between the link's endpoints as well as the link's weight;

FIG. 5 shows a network subgraph of node u with six relative neighbor nodes all at a distance d from node u, according to an embodiment of the present invention;

FIG. 6 is a flow chart illustrating methods of determining neighboring nodes with which to link a subject node to, according to an embodiment of the present invention;

FIG. 7 shows a high capacity subgraph for node u with a minimal bound on node degree, according to an embodiment of the present invention;

FIG. 8 illustrates a two-node-connected high capacity subgraph including all the links between u and neighboring nodes, according to an embodiment of the present invention; and

FIG. 9 shows a two-node-connected subgraph with a maximal node degree of 5, according to an embodiment of the present invention.

### DETAILED DESCRIPTION OF THE EMBODIMENTS

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements or control nodes (e.g., a scheduler located at a base station or Node B, a router located at a base station or Node B, a transmitter located at a base station or Node B, etc.). Such existing hardware may include one or more digital signal processors (DSPs), application-specific-integrated-circuits, field programmable gate arrays (FPGAs) computers or the like.

Embodiments of the present invention are directed to determining high capacity and fault resilient networks with a minimum bound degree by determining which nodes neighboring a subject node should be identified as neighbor nodes and thus be used to link the subject node within the wireless communication network. A link is defined herein as any type of communication connection between any two nodes, where a node is defined as a network element that acts as a communication point within a network. A path between nodes may include one or more links between the two nodes. In addition, the networks described may include distributed networks, for example, ad hoc mesh type networks.

In an embodiment of the present invention, a fault resilient high capacity network includes a two-node-connected network that contains a high capacity path between every pair of nodes, in the presence and/or absence of any node and/or link failure. The fault resilient high capacity network may also have a node degree of at most 10 where each node may only need to know about and communicate with neighbor nodes.

In another embodiment of the present invention a less strict high capacity network is determined using a two-node-connected network with a degree bound of five. In this type of network, the network guarantees that under any node and/or link failure, there is a path P between every pair of nodes u and v such that P's capacity is at least the same or higher than a high capacity path between some nodes of the network.

Embodiments of the present invention also include methods for determining the number of neighbor nodes for a subject node in a communication network to achieve various types of subgraphs and methods for determining the structure of such subgraphs based on the neighbor node configuration.

Throughout the following description, various definitions, assumptions, theorems, lemma, corollaries, etc. will be discussed. To begin, a path P may be defined between any pair of nodes u and v in a network as a high capacity path if there is no other path between u and v with a higher capacity than P. Accordingly, a network and/or a subgraph representing the network may be defined as a high capacity network and/or subgraph if, e.g., the subgraph contains such a high capacity path between every pair of nodes. Each wireless node is equipped with D tunable directional antennas for establishing high capacity point-to-point data connections with adjacent nodes. G(V, E_{G}) is denoted as an input graph related to the network, where V denotes a set of wireless nodes and E_{G} represents all the possible bi-directional point-to-point connections between the nodes. Each node u ε V may have a unique identification number denoted by IDᵤ.

Given the input graph G(V, E_{G}), embodiments of the present invention select subsets of potential links to form H (V, E_{H}) of G(V, E_{G}), where E_{H}⊂E_{G}, the degree of any node in H is at most D, and the subgraph H satisfies both fault resilience and high capacity network requirements. To provide fault resilience, H includes two node-disjoint paths between every pair of nodes. Node disjoint paths are two paths that share only the start and end nodes. For example, for nodes u, v there are at least two different paths connecting u and v, in addition to the path including the direct link between u and v.

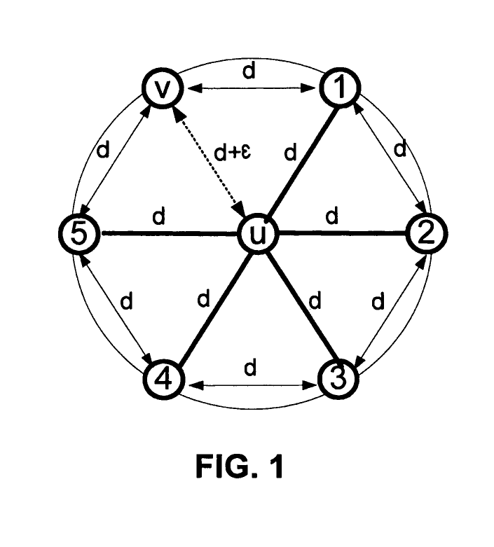

Each link (u, v) ε E_{G} is associated with at least one link parameter, e.g., distance, weight, etc. For purposes of discussion, let the parameter be link capacity denoted by c_{u,v}, which depends on the channel quality between the endpoints of the link. Usually, there is a correlation between node distance and channel quality, for example, in outdoor open space applications such as a fleet of cruising battleships, which self-organize into a multi-hop wireless mesh network. Often, the longer the distance between two nodes, the lower the channel capacity. For example, consider two adjacent nodes u, v ε V and let d_{u,v} denote the distance between the nodes as shown in FIG. 1. In this embodiment, the capacity c_{u,v} of the link (u, v) is inversely proportional to the distance between the nodes. A link may be established between two nodes only if their channel capacity is above a predetermined (or alternatively a given) threshold. The distance between two adjacent nodes is assumed to be known, for example, by using well known distance evaluation methods, and no two nodes are assumed to reside at exactly the same location. Based on the above assumptions, it follows that if node u and v are neighbors, then node u is also adjacent to any other node w that is even closer to u, i.e., d_{u,w}≦d_{u, v}.

For a path P_{x,y} between a pair of nodes x, y ε V, the path capacity C of P_{x,y} is the capacity of the link with the minimal capacity along the path, denoted by

C(P_{x,y})=min(_{u,v})εP_{x,y}C_{u,v} (1)

A path P_{x,y} is termed a high capacity path between nodes u and v if there is no other path between u and v in the graph G with higher path capacity as discussed earlier. A subgraph H(V, E_{H}) of G (V, E_{G}) is termed a high capacity subgraph if it contains for every pair of nodes u, v ε V at least one of their high-capacity paths in G.

Definition 1: (BOUNDED DEGREE HIGH-CAPACITY (HC) SUBGRAPH): Given an input graph G (V, E_{G}), this subgraph determines a minimal integer D_{HC} and a high capacity subgraph H(V, E_{H}) with maximal node degree of at most D_{HC}.

Definition 2: (BOUNDED DEGREE TWO-NODE—CONNECTED HIGH CAPACITY (2C-HC) SUBGRAPH): Given an input graph G (V, E_{G}), this subgraph determines a minimal integer D_{2NC-HC} and constructs a two-node-connected high capacity subgraph H(V, E_{H}) with node degree at most D_{2NC-HC}.

Definition 3: (BOUNDED DEGREE FAULT RESILIENT HIGH CAPACITY (FR-HC) SUBGRAPH): Given an input graph G (V, E_{G}), this subgraph determines a minimal integer D_{FR-HC} and constructs a two-node-connected high capacity subgraph H(V, E_{H}) of G (V, E_{G}) with node degree at most D_{FR-HC}. Also, for this subgraph, in the case of any node and/or link failure, the residual subgraph should remain a high capacity subgraph. Another way to define this subgraph is a two node-connected high capacity subgraph that preserves high capacity in the case of any node and/or link failure.

Definition 4: (BOUNDED DEGREE FAULT RESILIENT MAX-MIN-CAPACITY (FR-MMC) SUBGRAPH): Given a two-node-connected input graph G (V, E_{G}) with max-min capacity C*, this subgraph determines a minimal integer D_{FR-MMC} and a two-node-connected subgraph H(V, E_{H}) of G (V, E_{G}) with the degree of each node being at most D_{FR-MMC} and every pair of nodes having two-node disjoint paths between them with a path capacity of at least C. For this subgraph, let C_{u,v}^{w} denote the capacity of the high capacity path between nodes u and v after removing node w from G. Where the minimum capacity of G is defined as:

C*=MAX_{wεV}MIN_{u,v}εVC_{u,v}^{w} (2)

This subgraph has a less aggressive high capacity re-quirement than the FR-HC subgraph.

Theorem 1: Let T denote a minimal spanning tree (MST) of G (V, E_{G}). For any pair of nodes x, y ε V, the path P_{x,y} between the nodes x, y in T is a high capacity path.

Corollary 1: A subgraph of G (V, E_{G}) is a high capacity subgraph if it contains a minimal spanning tree of G.

Definition 5: (RELATIVE NEIGHBORS): Two adjacent nodes u, v ε V are relative neighbors (RN) if there is no other node y ε V where

w_{u,y}<w_{u,v} and w_{u,y}<w_{u,v} (3)

Consider a wireless network G(V, E_{G}) and assume each link e=(u, v) ε E_{G} is associated with a weight wₑ, which is the distance d_{u,v} between the nodes u, v εV and let w_{u,v}=∞ if u and v are not adjacent to one another.

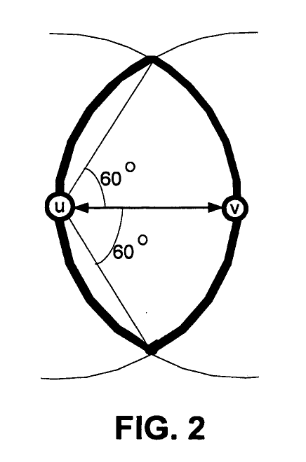

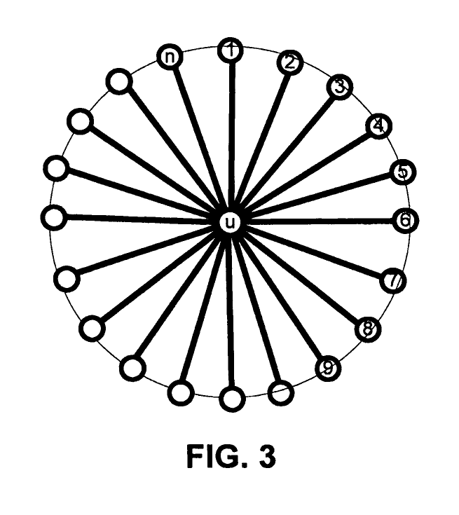

As shown in FIG. 2, Definition 5 implies that there is no node residing in the lune area defined by the intersection area of the two disks with radius d_{u,v} centered at u and v, respectively. A link (u, v) between two relative neighbors u and v is herein referred to as a relative neighbor link (RN-link), and the considered region is termed the lune of link (u, v). FIG. 3 shows that the number of relative neighbors of a node is unbounded as node u is surrounded by multiple nodes 1 to n all having the same distance from node u.

Definition 6: (ID)-BASED RELATIVE NEIGHBORS): Two adjacent nodes u, v ε V are called ID-based relative neighbors (ID-RN) if they are relative neighbors under the following link weight definition where the weight of link (u, v) is defined by the triplet,

w_{u,v}=<d_{u,v},ID₁,ID₂>. (4)

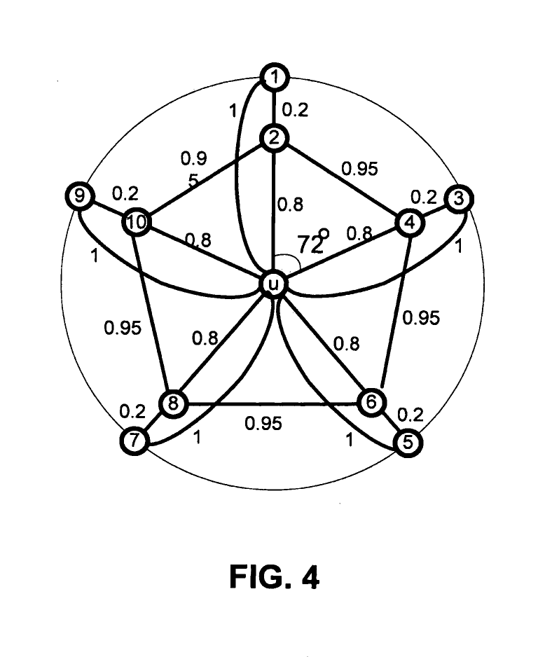

In the triplet, d_{u,v} is the original link weight, e.g., the distance between the nodes u and v, and ID₁=min{IDᵤ, IDᵥ} and ID₂=max{IDᵤ, IDᵥ}. Sᵤ denotes the set of ID based relative neighbors of node u. FIG. 4 shows an example embodiment of node u with five surrounding neighbor nodes (2, 4, 6, 8, and 10), and the relative link weights between node u and various neighbor nodes.

Definition 6 ensures a unique weight for each link. Under this definition, given two links e₁, e₂ ε E_{G}, Wₑ₁<wₑ₂ if wₑ₁ has a lower lexicographic value than the lexicographic value of wₑ₂. Based on definition 6, Lemmas 1 to 3 and Corollary 2 follow.

Lemma 1 (Symmetry): If v ε Sᵤ, then u ε Sᵥ, and Lemma 2: If v, y ε Sᵤ, then angle vuy≧60°.

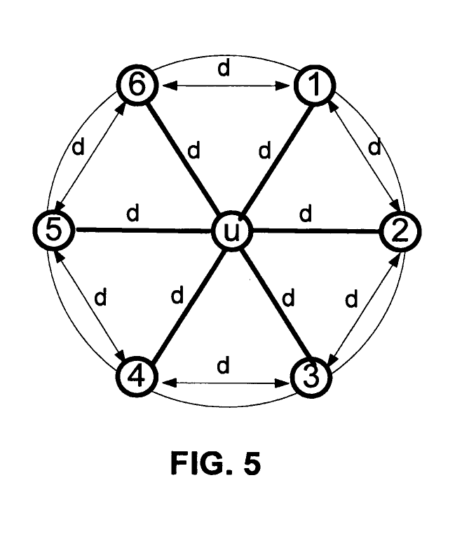

Corollary 2: Any node can have at most 6 ID-RNs as shown in FIG. 5, and Lemma 3: Let u be a node with 6 ID-RNs and assume the distance between u and one of its ID-RNs, e.g., v₁ ε Sᵤ is d. Then the distance between u and every node v₁ ε Sᵤ is d.

In view of the above, the placement of ID-RNs around a given node u herein referred to as a hexagon constellation, shown in FIG. 5, may cause the node to have an unnecessarily high degree or number of neighboring nodes. To avoid such cases, a weight modification process is used to ensure there is no node with a hexagon constellation of nodes around it. If a node u has a hexagon constellation Y of nodes with distance d from it, the weight modification process arbitrarily selects one node, e.g., v ε Y, and slightly increases its distance from u, e.g., by an infinitesimally small amount, denoted by ε. Thus, d_{u,v}=d+ε and the new weight of the link (u, v) is

w_{u,v}=<d_{u,v}+ε,ID₁,ID₂> (5)

where d_{u,v}, ID₁, and ID₂ are as defined in Definition 6. An example of this formation is shown in FIG. 1.

The weight modification process may be a localized process, for example, a node may only need to get the approval of its neighbor v to change the weight of the link (u, v). Then both nodes, u and v, may modify the link weight and distribute the new weight to their neighbor nodes and so on. Note that a node may have multiple hexagon constellations around it. Thus, after breaking a hexagon constellation around u, a review of the other nodes in the vicinity may continue to check for possible hexagon constellations. If a hexagon constellation is found, the weight modification process is repeated. The weight modification process may be repeated until there are no hexagon constellations around u.

Also, the weight modification process done by other nodes may affect the ID-RN set for node u, so node u may need to verify that the new link weights do not yield another hexagon constellation. Further, to avoid similar situations, the weight of an RN-link (u, vj) vj ε Y may be modified only if the weights of the RN-links (u, vⱼ₋₁) and (u, vⱼ₊₁) have not been modified. Modulo 6 may be used to keep the node index in the range of 0 to 5.

Lemma 4: After the weight modification process there is no node u with a hexagon constellation of nodes around it.

Theorem 2: Consider a hexagon constellation Y around node u. After the weight modification process, at most 5 of the nodes in Y are ID-RNs of u, regardless of the other nodes in the vicinity of u as shown in FIG. 1.

Definition 7: (WEIGHTED RELATIVE NEIGHBORS OR DETERMINED SET OF NEIGHBOR NODES): Two adjacent nodes u, v ε V are called weighted relative neighbors (WRNs) if they are relative neighbors according to the link weight determined by the weight modification process. Ŝᵤ denotes the set of weighted relative neighbors of node u. An example of a node with 6 ID-RNs but only 5 WRNs is shown in FIG. 1.

Lemma 5 (Symmetry): If u ε Ŝᵤ, then v εŜᵤ, and Lemma 6: Every node has at most 5 WRNs.

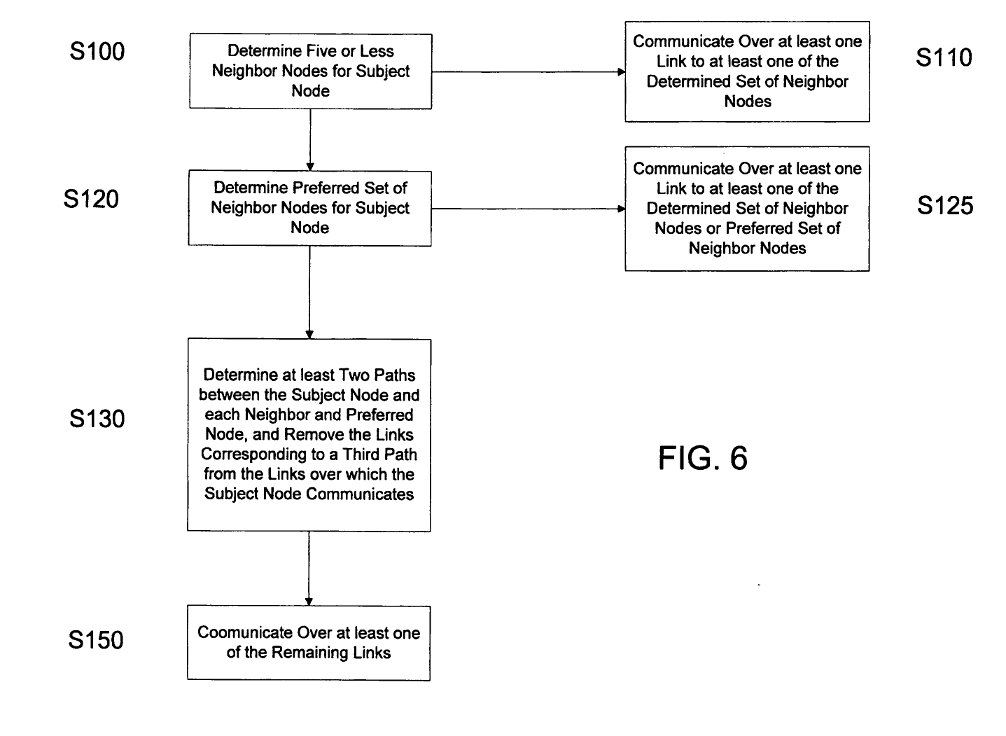

An embodiment of the present invention providing a method for determining neighbor nodes with which to link in a wireless communication network, will now be discussed with reference to FIG. 6. A person of ordinary skill in the art would recognize that the steps discussed may be performed by software, e.g., programs, codes, etc. or may be hardwired into hardware included in, e.g., network nodes, a Node B, base station, base transceiver station, etc. In addition, the software may be encoded on computer readable mediums, e.g., optical disks, memories, digital storage media, etc. used at network nodes.

The method shown in FIG. 6 includes three primary steps, S100, S120, and S130 for determining neighbor nodes to a subject node and three communication steps, S110, S125, and S150, in which the subject node communicates over at least one link with at least one of the determined neighbor nodes.

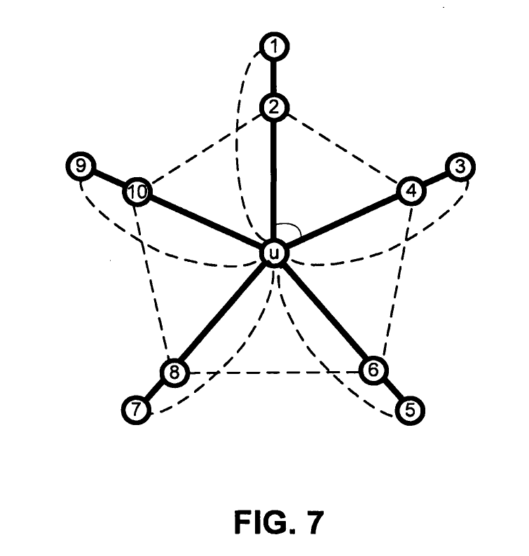

In step S100, a high capacity subgraph as defined above is determined. For purposes of ease of description, the subgraphs refer to node u as an example subject node, however it is to be understood that for each node in the network the methods discussed may be repeated. To determine the subgraph, node u evaluates the distance (e.g., or link capacity, etc.) to each of its neighbors in G and determines its set of ID-RNs as discussed above. If necessary, node u conducts the weight modification process described above to ensure that node u does not have a hexagon constellation around it. Once node u determines its set of weighted relative neighbors Ŝᵤ and the corresponding links, node u may then communicate over at least one link between node u and the corresponding weighted relative neighbors in step S110. FIG. 7 shows an example of a high capacity subgraph as determined in step S100 including the links between node u and the determined set of neighbor nodes (2, 4, 6, 8, and 10).

Theorem 3: The subgraph T(V,E_{T}) calculated in step S110 is a high capacity subgraph with a maximal node degree 5.

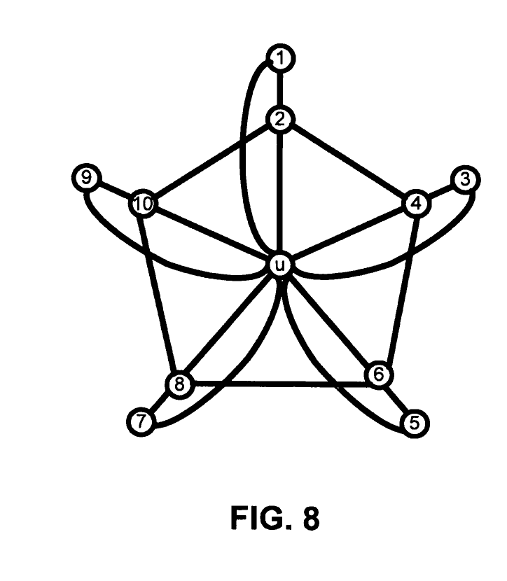

In step S120, a fault resilient high capacity subgraph as defined above is determined. To determine this subgraph, each node u iteratively calculates a set of new preferred neighbor nodes denoted by Zᵤ. In each iteration, node u temporarily ignores a neighbor v ε Nᵤ and determines a set of new preferred WRNs denoted by Zᵥ^{u}. The set of new preferred neighbors Zᵤ is the union of the new WRN sets Zᵥ^{u} of every neighbor v ε Nᵤ. An example embodiment of subgraph H(V, E_{H}) is shown in FIG. 8 where the high capacity subgraph shown in FIG. 7 is augmented with the links between every node and its new preferred neighbors in Zᵤ. In step S125, node u may communicate over at least one of the identified links between itself and at least one of the determined set of neighbor nodes and the set of preferred neighbor nodes.

Steps S100 and S120 may both be localized, e.g., requiring only the exchange of local information between adjacent nodes.

Theorem 4: If the input graph G(V,E_{G}) is two-node-connected then H(V, E_{H}) is a fault resilient high capacity subgraph of G, and Theorem 5: The maximal node degree of H(V, E_{H}) is at most 10.

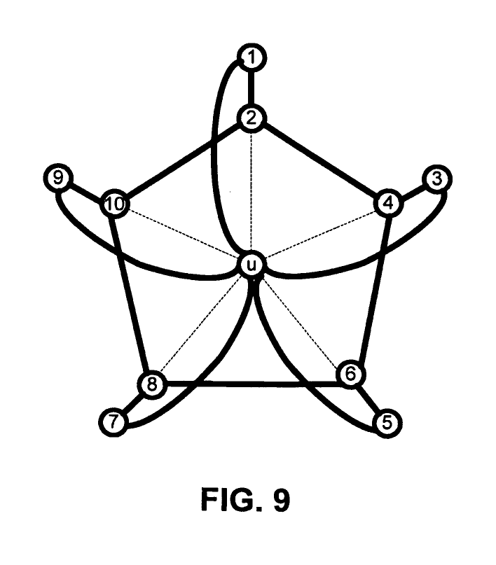

In step S130, the fault resilient high capacity subgraph shown in FIG. 8 is “trimmed” to obtain a fault resilient max-min capacity subgraph with a maximal node degree of 5. For step S130, each node has disseminated its Ŝᵤ and Zᵤ sets of neighbors so H(V, E_{H}) is known to all nodes. The max-min subgraph, J(V, E_{J}), is determined by removing from H the low capacity redundant links that are not needed for maintaining two-node-connectivity. For example, links in E_{H} are arranged in decreasing order of weight and for each examined link (u, v), if the subgraph H contains two node-disjoint paths between u and v without the direct link (u, v), link (u, v) may be removed from H. An example embodiment of the resulting subgraph is shown in FIG. 9. In step S150 of FIG. 9, node u may communicate over at least one of the remaining links from the fault resilient high capacity subgraph once the links corresponding to any redundant paths are removed.

Theorem 6: If the input graph G(V,E_{G}) is two-node connected then the subgraph J(V, E_{J}) is a fault resilient max-min capacity subgraph of G.

Lemma 12: For any node with 3 or more neighbors in J and any two nodes v, y ε Wᵤ, either angle vuy>60°, or angle vuy=60° and d_{u,v}=d_{u,y}, where Wᵤ denotes all the neighbors of node u in J.

Theorem 7: The degree of any node in J is at most 5.

The FR-HC networks may provide the highest possible capacity guarantees for all nodes, not only in normal cases but also in the presence of any node and/or link failure. Although the improved capacity performance may be achieved at the cost of a relatively higher node degree, the achieved degree bounds may be considered moderate (up to 8). Alternatively, the FR-MMC networks may provide the lowest possible degree bound guarantee, whereas the provided capacity guarantee is relatively lower than that provided by FR-HC. Nevertheless, the path capacities provided by FR-MMC networks may still be considered improved as compared to previous path capacities.

The invention being thus described, it will be obvious that the same may be varied in many ways. Such variations are not to be regarded as a departure from the invention, and all such modifications are intended to be included within the scope of the invention. The present invention may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

It is noted that the terms used to identify the various types of neighbor nodes are only examples of such terms, and the terms may change according to the service provider, the network, etc. As used herein, the term “and/or” includes any and all combinations of one or more of the associated listed items. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

Portions of the present invention and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities.

Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

We claim:

1. A method of determining neighboring nodes with which to link in a wireless communication network, comprising:
determining, at a subject node, a set of five or less neighbor nodes from a plurality of neighbor nodes neighboring the subject node; and
communicating, from the subject node, over at least one link to at least one of the determined set of neighbor nodes.

2. The method of claim 1, further including:
determining a preferred set of neighbor nodes from the plurality of neighbor nodes, excluding the determined set of five or less neighbor nodes; and
wherein the communication step further includes, communicating, from the subject node, over at least one link to at least one of the determined set of neighbor nodes and over the at least one link to at least one of the determined preferred set of neighbor nodes.

3. The method of claim 2, further including:
determining at least two paths'including one or more links, between the subject node and at least one neighbor node from the set of neighbor nodes and the preferred set of neighbor nodes; and
removing links corresponding to a third path between the subject node and the at least one neighbor node from the links over which the subject node communicates.

4. The method of claim 3, wherein the determining at least two paths, further includes:
determining for each neighbor node in the set of neighbor nodes and the preferred set of neighbor nodes, whether at least two different indirect paths between the subject node and each neighbor node in either set of neighbor nodes exists without including a direct path between the subject node and each of the neighbor nodes in either the determined set of neighbor nodes or the preferred set of neighbor nodes; and
removing the links corresponding to the direct path between the subject node and a neighbor node from the links over which the subject node communicates, if at least two different indirect paths exist between the subject node and the neighbor node.

5. The method of claim 3, wherein the communicating, from the subject node, over at least one link, further includes:
communicating over a fault resilient communication link.

6. The method of claim 2, wherein a number of neighbor nodes in the determined set of neighbor nodes and the determined preferred set of neighbor nodes is equal to or less than 10 nodes.

7. The method of claim 2, wherein the determining a preferred set of neighbor nodes further includes:
determining a plurality of second sets of neighbor nodes for the subject node, each second set of neighbor nodes being based on temporarily ignoring a different one of the determined neighbor nodes; and
selecting a union of the second sets of neighbor nodes to form the preferred set of neighbor nodes.

8. The method of claim 2, wherein the communicating, from the subject node, over at least one link, further includes:
communicating over a fault resilient high capacity communication link.

9. The method of claim 1, wherein the determining a set of five or less neighbor nodes, further includes:
determining a relative set of neighbor nodes for the subject node from the plurality of nodes neighboring the subject node based on a value of at least one link parameter between each of the neighboring nodes and the subject node.

10. The method of claim 9 wherein the determining a set of five or less neighbor nodes further includes:
selecting one of the determined relative neighbor nodes;
increasing the value of the at least one link parameter between the selected determined relative neighbor node and the subject node; and
excluding the selected determined relative neighbor node from the set of determined relative neighbor nodes to form the determined set of neighbor nodes.

11. The method of claim 10, wherein the determining a set of neighbor nodes further includes:
not forming a hexagon constellation around any other node of the plurality of nodes.

12. The method of claim 9, wherein the set of relative neighbor nodes includes at most 6 nodes and the angle formed between the subject node and two relative neighbor nodes is greater than or equal to 60°.

13. The method of claim 1, wherein the communicating, from the subject node, over at least one link, further includes:
communicating over a high capacity communication link.

14. A computer readable medium encoded with a method of determining neighboring nodes with which to link a subject node in a wireless communication network, the method comprising:
determining, at a subject node, a set of five or less neighbor nodes from a plurality of neighbor nodes neighboring the subject node;
determining a preferred set of neighbor nodes from the plurality of neighbor nodes, excluding the determined set of five or less neighbor nodes;
determining at least two paths including one or more links, between the subject node and at least one neighbor node from the determined set of neighbor nodes and the determined preferred set of neighbor nodes;
communicating, from the subject node, over at least one link to at least one of the determined set of neighbor nodes and over the at least one link to at least one of the determined preferred set of neighbor nodes, the at least one link not including links corresponding to a third path between the subject node and the at least one neighbor node.

15. The computer readable medium of claim 14, wherein the communicating, from the subject node, over at least one link, further includes:
communicating over a fault resilient communication link.

16. A network element, comprising:
means for determining a set of five or less neighbor nodes from a plurality of neighbor nodes neighboring the network element; and
means for communicating over at least one link to at least one of the determined set of neighbor nodes.

17. The network element of claim 16, further comprising:
means for determining a preferred set of neighbor nodes from the plurality of neighbor nodes, excluding the determined set of five or less neighbor nodes; and
means for communicating over at least one link to at least one of the determined set of neighbor nodes and over the at least one link to at least one of the determined preferred set of neighbor nodes.

18. The network element of claim 17, further comprising:
means for determining at least two paths including one or more links, between the network element and at least one neighbor node from the set of neighbor nodes and the preferred set of neighbor nodes; and
means, for removing links corresponding to a third path between the network element and the at least one neighbor node from the links over which the network element communicates.
